(19) United States
(12) Patent Application Publication
(10) Pub. No.: US 2006/0041856 A1
(43) Pub. Date: Feb. 23, 2006

(54) Integrated project tracking tool for integrated development environment

(75) Inventors: Lane Thomas Holloway, Pflugerville, TX (US); Walid M. Kobrosly, Round Rock, TX (US); Nadeem Malik, Austin, TX (US); Marques Benjamin Quiller, Pflugerville, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/922,245

(22) Filed: Aug. 19, 2004

(51) Int. Cl. G06F 9/44

(52) U.S. Cl. 717/101

(57) ABSTRACT

Methods, systems, and media are disclosed for tracking code development. One embodiment includes receiving, by a single application within an integrated development environment, a status request. Further, the embodiment includes requesting, by the single application, data, responsive to the status request, from at least one management tool in communication with the single application. The embodiment also includes passing the data from the at least one management tool to the single application. Finally, the embodiment includes generating, by the single application, a status report based on the data. Additional embodiments include publishing the status report, wherein the publishing may be audio, visual or both, configuring an interface for the status report, and storing one or more versions, including the most current version, of the status report.

### FIELD OF INVENTION

The invention generally relates to tracking code development. More particularly, the invention relates to methods, systems, and media for tracking code development through a single application, such as a plug-in, within the integrated development environment, wherein code developers and managers use the single application to easily access, modify, and generate code development metrics, as well as to seek approval for the same.

### BACKGROUND

Often two or even a team of computer programmers, i.e., developers, write a computer program's code (“code”). The code, itself, is a set of instructions, written in one or more computer languages, such as C, C++, and Java, for a computer system to interpret and execute in order to produce a particular program's underlying functionality. The process for writing the code, which forms the basis of the program, is called code development.

Code development is an arduous, complex, and time-consuming task—especially so for code employing novel programming techniques, enabling innumerable functionalities, and requiring thousands or even millions of lines of code. Oftentimes, a team of developers develops the code within an integrated development environment (“IDE”). An IDE, itself, is a programming environment integrated into a software application that often provides a graphical user interface (“GUI”) builder, a text or code editor, a compiler, and/or interpreter, and a debugger. With the IDE, developers meet the daunting challenges of code development: designing and planning system architecture, as well as writing, editing, and re-writing endless lines of code, usually located in an accessible code repository, to produce a final and current version of the code. Examples of IDEs include Eclipse™, Visual Studio®, Delphi®, JBuilder®, FrontPage® and DreamWeaver®, wherein the latter two are for HTML and web page development.

Turning from a developer's to a project management's perspective, scheduling and trackable metrics are also a vital and practical component of code development. That is, alongside writing the code, business concern, such as financial, time, and manpower constraints, necessitate accurate scheduling and metrics, e.g., lines of code per day by a developer, lines of good code, time remaining, cost to complete, etc. So, today, in order to manage code development, a collaborative team of a project manager and developers normally track code development through management tools, such as Rational Rose®, Microsoft Project®, Bugzilla®, and so forth.

Despite an IDE tool and various management tools, code development remains cumbersome because developers must go in and out of the IDE and multiple management tools to determine answers to various questions, such as: how productive a developer is, what is the current estimated time to complete a certain portion of the code, what is the cost to complete, is a particular developer on vacation, how “buggy” is a particular developer code from yesterday, can more time be obtained for writing a particularly difficult section of the code, what is today's code development status rather than the outdated status from six months ago, etc. Because the state of the art is cumbersome, what is needed, therefore, are streamlined methods, systems, and media for tracking code development, especially ones that provide current code development status, and optionally permits communication for modifying the status and for deriving metrics from the status.

### SUMMARY OF THE INVENTION

Embodiments of the invention generally provide methods, systems, and media for tracking code development. In one embodiment, the improved method for tracking code development comprises receiving, by a single application within an integrated development environment, a status request. Further, the method includes requesting, by the single application, data, responsive to the status request, from at least one management tool in communication with the single application. Further still, the method includes collecting the data from the at least one management tool to the single application, and generating, by the single application, a status report based on the data.

In another embodiment, the invention provides a system for tracking code development. The system generally includes a single application within an integrated development environment, wherein the single application contains modules. The single application includes a receiver module for receiving a status request. Further, the single application includes a request module for requesting data for the status request from at least one management tool in communication with the single application. Further still, the single application includes a collection module for receiving the data from the at least one management tool, and a generation module for generating a status report based on the data.

In yet another embodiment, the invention provides a machine-accessible medium containing instructions for tracking code development, which when executed by a machine, cause the machine to perform operations. The instructions generally include operations for receiving, by a single application within an integrated development environment, a status request. The instructions further include operations for requesting, by the single application, data, responsive to the status request, from at least one management tool in communication with the single application. Further still, the instructions further include operations for collecting the data from the at least one management tool to the single application, and operations for generating, by the single application, a status report based on the data.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts an overview of a system for tracking code development in accordance with the disclosed invention.

FIG. 2 depicts an example embodiment of a system for tracking code development in accordance with the disclosed invention.

FIG. 3 depicts an example embodiment of a status report generable for tracking code development in accordance with the disclosed invention.

FIG. 4 depicts an example embodiment of a flowchart for tracking code development in accordance with the disclosed invention

FIG. 5 depicts an example embodiment of a computer system capable of use for tracking code development in accordance with the disclosed invention.

### DETAILED DESCRIPTION OF THE EMBODIMENTS

The following is a detailed description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, systems, methods, and media for tracking code development are contemplated. Embodiments include an integrated development environment (“IDE”), which, generally, is understood to be accessed by a plurality of networked computer systems that a collaborative team of developers and one or more managers use to systematically develop code for a computer program. Specifically, an IDE is a programming environment integrated into a software application that often provides a graphical user interface (“GUI”) builder, a text or code editor, a compiler, and/or interpreter, and a debugger. A code repository, that is, for holding, as well as checking in and out, the code under development is also usually associated with the IDE. Within the IDE, embodiments further include a single application, such as a plug-in to the IDE, for facile management and querying of current code development status. The single application includes functionalities, whether in one or a plurality of modules, for receiving a status request, from, for example, a developer. The status request may be, for example, a request for an extension of time to develop a certain portion of the code or for the number of bugs in a certain portion of code developed by the same or another developer. Regardless, after receiving the status request, the single application communicates with a management tool to provide data responsive to the status request. For example, the status request may request approval from a manager to extend the time to develop a portion of the code by asking a project manger using a management tool, such as Rational Rose®. After requesting the data, such as an approval, this data is communicated back to the single application; that is, the single application collects the requested data. After collection, the single application generates a status report, such as a single viewable page within the IDE, whereby such a page is a pre-configurable report of data and metrics providing the requester, e.g., a developer, with a convenient and current status of the code being developed without having to go in and out of multiple management tools.

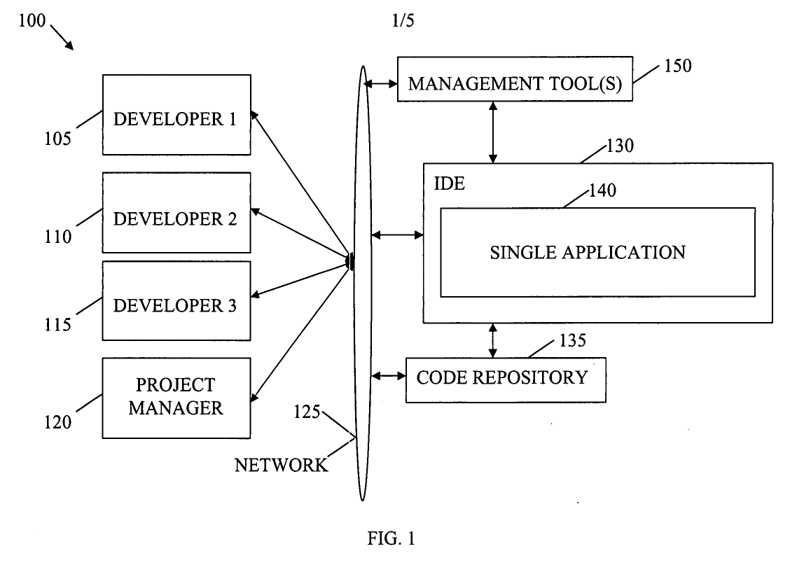

Turning now to FIG. 1, a general overview of a system 100 for tracking code development, in accordance with the invention, is disclosed. The system 100 includes one or more computer systems, likely used by developers, and, as depicted in FIG. 1, the system 100 includes three such computer systems, namely 105, 110, and 115. For ease of discussion, further reference is made only to computer system 105, but it is understood that many more developer computer systems than even 105, 110, and 115 are possible without departing from the invention.

Developer computer system 105, which optionally includes a host of physical and logical peripherals, connects, through network 125 communication, such as a LAN or WAN, to a local or remote server, for instance, having an IDE 130. The IDE 130, such as Eclipse, is a tool used by code developers, likely managed by at least one project manager using the project manager's computer system 120, which is also in network 125 communication with the IDE 130. Although the components of the IDE 130 are not depicted, as previously explained, the IDE 130 is a programming environment integrated into a software application that usually provides a graphical user interface (“GUI”) builder, a text or code editor, a compiler, and/or interpreter, and a debugger. Although the IDE provides the environment and tools for actual code development, e.g., writing, and is normally associated with a code repository, such as Concurrent Versions System (“CVS”), Perforce® or Visual SourceSafe®, management tool(s) 150 are often used in parallel with the code development. That is, management tool(s) 150 used in conjunction with coding are not integrally associated with the IDE 130. The management tool(s) 150, whether one or many, are normally used by a project manager and developers to follow, that is, track, the code development process. Example management tool(s) 150 include Rational Rose®, Microsoft Project®, Bugzilla®, and through use of such management tool(s) 150, the current schedule and metrics for code development are tracked. In the system 100, however, rather than the IDE 130 and management tool(s) 150 existing in parallel, even if mutually accessible, universes, a single application 140, such as a plug-in, is incorporated into the IDE 130. From the single application 140 within the IDE 130, the single application 130 communicates through the same or a different network 125, with the management tool(s) 150, as well as with the developer 105 and project manager 120 computer systems. In this manner, the system 100 is seamless in that the system 100 unites the management and coding components of code development, and, thereby, facilitates streamlined tracking of code development.

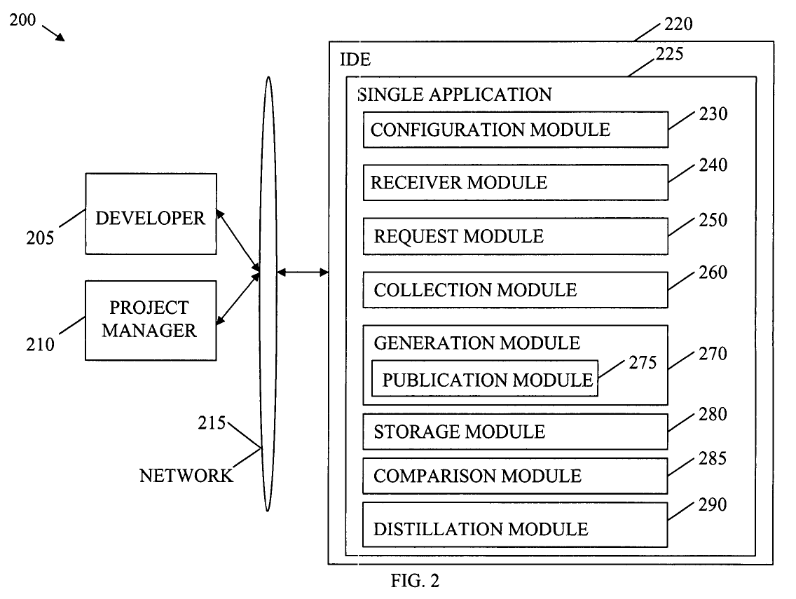

Now, moving to FIG. 2, a more detailed discussion of a system 200 for tracking code development ensues. As previously discussed and shown in FIG. 1, FIG. 2 also depicts a developer's 205 computer system and a project manager's 210 computer system in network 215 communication with the IDE 220 having the single application 225, wherein the IDE 220 is likely located on a server accessible to the collaborative code development team members. Unlike FIG. 1, FIG. 2 drills down into the functionalities of the single application 225, such as a plug-in or similar modular component, integrated into the IDE 220.

Before discussing the individual and various functionalities of the single application 225, it is worth including that although FIG. 2 depicts multiple, intercommunicating modules, it is understood that these functionalities could just as easily be incorporated into one large module or another arrangement without departing from the functionalities of the single application 225. Referring now to one of the modules depicted in FIG. 2, the single application 200 is shown to include a configuration module 230 for configuring an interface of a status report ultimately generated by the system 200. Optionally having a default configuration, the configuration module 230, enabled by coded software and/or logic reduced to hardware, permits a user, such as a developer 205 or project manager 210, to configure both the desired metrics for output and the appearance of the status report interface generated by the system 200.

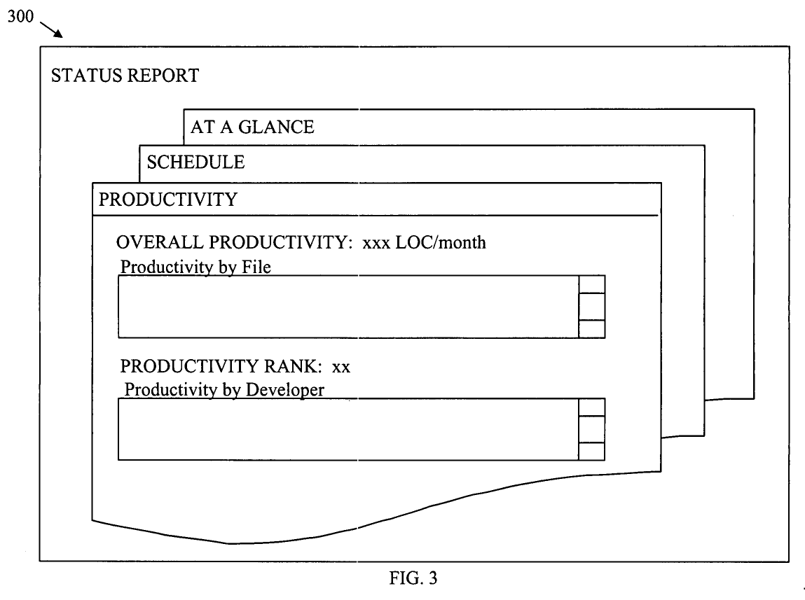

As an example, FIG. 3 shows a status report having an interface 300 that may be generated by the system 200. The example interface 300 shows a status report three pages deep, wherein the top-most page is entitled “productivity,” the middle page is entitled “schedule,” and the back-most page is entitled “at a glance.” In this example, The productivity page shows the overall productivity, in terms of line of code (“LOC”) with a scrollable box, for instance, that includes the status of various files of code being developed. In addition, the example productivity page also shows the productivity, in terms of LOC per day, of each of the developers on the code development team. By further example, although not depicted, the configuration module 230 may also permit the interface to include other metrics, such as completion timelines for all or particular portions of the code under development, financial allocations for the same, comment fields, efficient coding, “bugginess” of written code, and so forth, all of which may be for reported on a per day, per month, per team, or per developer basis.

In addition to which metrics to include on the status report interface, the configuration module 230 also permits the user, likely a developer or project manager, to determine the format *for displaying the desired metrics. That is, the configuration module 230 permits the user to choose, for example, from a one-page or multi-page overview, and whether to report the metrics in pictorial graphics, whether in one, two or three dimensions, in scrollable boxes, in pull-down menus, etc.

Returning to FIG. 2, and after optionally pre-configuring the interface of the status report with the configuration module 230, the single application 225 shows a receiver module 240. The system 200 includes a receiver module 240 for receiving a status request, which likely comes from the developer 205 by way of network 215 communication with the IDE 225 having the single application 225. The receiver module 240, enabled by software and/or hardware, is for receiving the status request, which is the incoming request for the status report. The status request, itself, may be, for example, the system 200 user's generalized request for a current status report, a request for approval from the project manager for modifying an existing deadline for a particular section of code under development, a request to update a particular section of code under development, a request to generate metrics for the last six months of code development, and so forth.

After receipt of the status request by the receiver module 240, the single application 225 further includes a request module 250. By enabling software and hardware, the request module 250 receives the status request from the receiver module 240, and then queries the system 200 for data responsive to the particular status request. As an example, considering the single application 225 as a Java® plug-in, the enabling logic for the request module 240 may include database connectors. Such connectors connect to management tools, which are understood in its broadest sense so as to include any program or peripheral, such as a database containing the data responsive to the status request. More particularly, for a status request requiring data from a bug-tracking database, a Java® connector may be part of the enabling logic that links, and makes possible, the requesting of data from a management tool, such as a bug tracking database; thereby, bug tracking metrics for all or even a particular developer are requested. By another example, similar types of connectors may be part of the enabling logic for a status request that seeks, for one, a project manager's approval to extend the deadline for a particular piece of code under development. In such a case, a connector associated with the receiver module 240 communicates with a management tool, such as Rational Rose®, used by the project manager, to request the extension. Although the above examples are illustrative of enabling logic and types status report requests, it is understood that many more possibilities of both exist, which are deemed to be within the scope of the invention.

Working closely in tandem with the request module 250 is the collection module 260. Similar to the request module 250, the collection module 260 has enabling coded logic and/or logic reduced to hardware for collecting the data requested by the request module 250. That is, the same, example connectors providing enabling logic for requesting the data for the single application 225 may also provide the enabling logic for collecting, i.e., returning, the requested data back to the single application 225. In this manner, the collection module 260 simply gathers the requested data for the status request already harvested by the request module 250.

With the single application 225 now having the collected data, a further module, namely a generation module 270, provides the functionality for generating a status report that at least includes the collected data responsive to the status request. By intra-application communication with the configuration module 230, the generation module 270, through enabling software and/or hardware, generates a status report having a default or pre-configured interface, such as the status report depicted in FIG. 3. Although the generation module 270 may simply save, for example, the generated status report as a file on the server having the single application 225, an associated publication module 275 may publish the status report. Publication may be to a visual display (e.g., computer screen), audile unit (e.g., speakers), or both that is associated with the developer 205 and/or project manager 210.

Additionally within the IDE 220, the single application 225 further and optionally includes a storage module 280, a comparison module 290, and a distillation module 295. Each of these further modules is enabled by software and/or hardware, and provide the system 200 with additional functionalities. The storage module 280 operates to store any or all previous status reports, as well as the current status report, generated by executions of the generation module 270, and may permanently identify, for example, the plurality of generated status reports by stamping such stored status reports with a date and time at the time of storage. For actual storage, the single application 225 further includes accessible memory, such as ROM, associated with the system 200.

The distillation module 295 provides the system 200's single application 225 with the further functionality of distilling additional metrics from the current and/or previous status reports generated and stored by the system 200. In order to distill additional metrics, such as a status request for a bug ratio comparison in LOCs for each developer for the last six months, a user, such as a developer 205 or project manager 210, uses the distillation module 295, which works with the comparison module 290, to compare the bugs in LOCs per developer by accessing the stored, previous (i.e., historical) status reports for the last six months. The distillation module 295 then accesses the generation module 270, which optionally accesses the configuration manager, to generate the distillation status report to generate the bug ratio comparison in LOCs for each developer for the last six months.

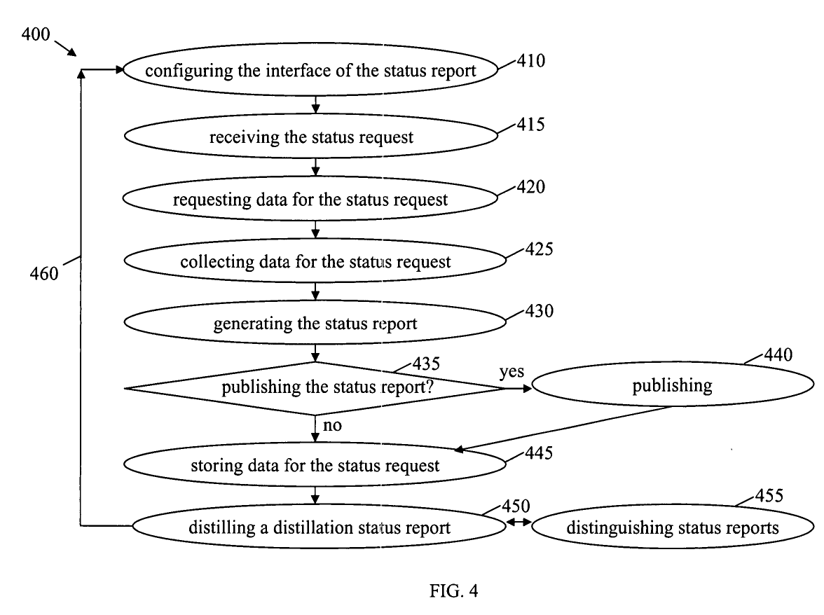

Turning now to FIG. 4, another aspect of the invention is disclosed. In particular, an embodiment of a flowchart 400 for tracking code development is disclosed. Flowchart 400 is for a system, such as systems 100 and 200, as shown in FIG. 1 and FIG. 2. In general, the flowchart 400 depicts example embodiments of methods for tracking code development through use of a single application, such as a plug-in, integrated into an IDE, whereby developers' and project managers' use of the single application melds access and utilization of management tools, such as databases holding statistics and metrics, as well customarily used software applications, such as Microsoft Project®, into the IDE so as to avoid time-consuming, cumbersome, and avoidable entries into and exits from the IDE for status reports on code development.

Flowchart 400 begins by optionally configuring 410 the interface of the status report ultimately generated by the flowchart 400. The configuring 410 from an optionally default interface for the status report allows a user, such as a developer or project manger, to determine the appearance and metrics/statistics to appear on any kind of status report, including a distillation status report, capable of generation as shown by the flowchart 400. Enabled by logic found in accompanying software and/or hardware, the configuring 410 of the interface's appearance is understood to be the format for the status report. By reference to FIG. 3, the appearance of this example interface shows scrollable boxes used in a chosen three-page deep status report on “productivity,” “schedule” and “at a glance.” Through this chosen configuring 410, the user, for example, may use a mouse associated with the user's computer system in network communication with the single application on the IDE to click between the three pages of the status report to find out the productivity, schedule or at a glance data gathered and collected in response to a status request for a status report. In addition to the formatting of the interface, the configuring 410 includes the user choosing, that is, configuring, the particular statistics desired to sometimes or always be reported in response to a particular or general status request. For example, the configuring 410 may include always showing productivity in terms of LOC or bug-free LOC. In short, the permutations of the possible format and data to be included for the interface are limitless, and are only limited by the choices presented to the user in the enabling software and/or hardware for the configuring 410.

After optional configuring 410, the flowchart 400 continues by receiving 410 a status request by the single application integrated into the IDE. The receiving 410 of the status request by the single application is the receipt of a user's request for what may be a generalized status report on the overall code development status, or even include more particularized requests from the user such as a particular code developer's productivity, a request for approval to extend a particularly difficult section of coding, and so forth. The single application receives 410 the status request from a user, such as a developer or project manager, using a computer system in network communication with the IDE.

The flowchart 400 continues by requesting 420 data responsive to the status request. Through software and/or hardware logic found within a plug-in integrated into the IDE, for example, the requesting 420 is the single application's querying of accessible management tools in order to locate and find the data responsive to the status request, whereby the collecting 425 of this data is returned to the single application. If the single application is a plug-in, for example, then accompanying connectors, designed to be compatible and communicate with various management tools, such as databases and proprietary and commercially available software applications like Rational Rose®, request 420 and collect 425 the data responsive to the status request. In this manner, for instance, the single application may request and collect, i.e., receive, the status request's approval or disapproval for an extension for coding a particularly difficult section from a project manager using a management tool, the status request's desire for productivity metrics, or the status request's desire to update the existing code development schedule.

After collecting 425 the data responsive to the status request, the raison d'être of the flowchart 400 continues by generating 430 the status report having the format and content optionally dictated by the configuring 410. The generating 430 uses the collected data to produce the status report, which is optionally published as shown by the publication decision block 435. If the user of the single application wishes to publish the status report, or if automatic publication occurs after the generating 430 as pre-determined by the configuring 410, then publishing 440 of the status report occurs. The publishing 440, for instance, ensues by publishing to a visual display, such as a computer screen, in network communication with a developer's computer system. Additionally and alternatively, the publishing 440 may be to an audio unit, such as speakers in network communication with a developer's computer system. If however, the publication decision block 435 results in no publishing, then, as with after actual publishing 440, the generated status report is stored 445 in accessible memory associated with the single application.

Moving down the flowchart 400 toward completion, the flowchart 400 shows further example embodiments of a method for tracking code development. After generating 430 the status report, a project manager, for instance, may wish to distill 450 additional metrics from the status report as compared to previously stored status reports in a memory associated with the system, such as systems 100 and 200 in FIGS. 1 and 2, respectively. As an example of distilling 450 additional metrics from a generated status report and one or more historically stored status reports, a developer may wish to determine the number of requested extensions for code a particular developer has requested over the last year of the code development. The flowchart 400 processes the distilling 450 by distinguishing 455 the current and previous status reports, which involves comparing the current and stored status reports over the past year. Further, by relation back arrow 460, the distilling 450 continues by optionally referring to the configuring 410 for the format and content of the distillation status report. Thereafter, the distilling 450 continues back down the flowchart 400, wherein the number of requested extensions for code a particular developer has requested over the last year of the code development operates as a status request for the ultimate generating 435 and optional publishing 440 of the distillation status report.

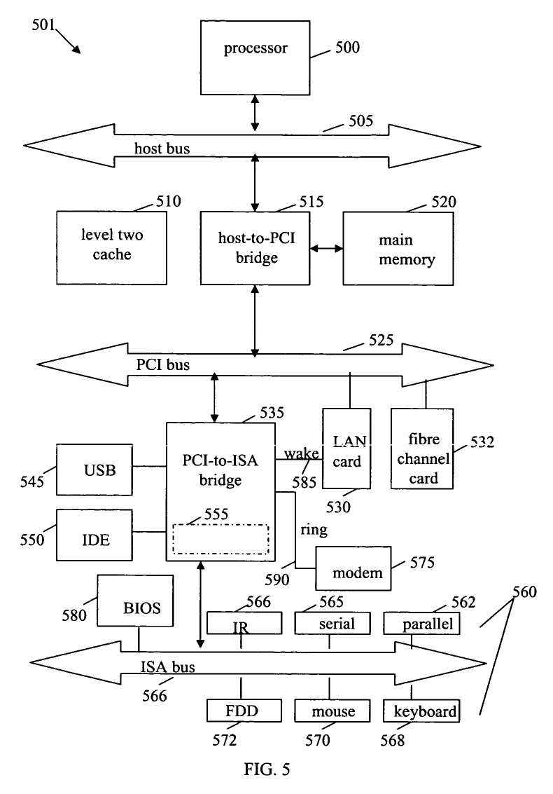

FIG. 5 illustrates an information handling system 501 which is a simplified example of a computer system, such as the developer computer systems 105, 110, and 115 and project manager computer system 120 in FIG. 1, and developer computer system 205 and project manager computer system 210 FIG. 2, which are capable of performing the operations described herein. Computer system 501 includes processor 500 which is coupled to host bus 505. A level two (L2) cache memory 510 is also coupled to the host bus 505. Host-to-PCI bridge 515 is coupled to main memory 520, includes cache memory and main memory control functions, and provides bus control to handle transfers among PCI bus 525, processor 500, L2 cache 510, main memory 520, and host bus 505. PCI bus 525 provides an interface for a variety of devices including, for example, LAN card 530. PCI-to-ISA bridge 535 provides bus control to handle transfers between PCI bus 525 and ISA bus 550, universal serial bus (USB) functionality 545, IDE device functionality 550, power management functionality 555, and can include other functional elements not shown, such as a real-time clock (RTC), DMA control, interrupt support, and system management bus support. Peripheral devices and input/output (I/O) devices can be attached to various interfaces 560 (e.g., parallel interface 562, serial interface 565, infrared (IR) interface 566, keyboard interface 568, mouse interface 570, fixed disk (HDD) 572, removable storage device 575) coupled to ISA bus 550. Alternatively, many I/O devices can be accommodated by a super I/O controller (not shown) attached to ISA bus 550.

BIOS 580 is coupled to ISA bus 550, and incorporates the necessary processor executable code for a variety of low-level system functions and system boot functions. BIOS 580 can be stored in any computer readable medium, including magnetic storage media, optical storage media, flash memory, random access memory, read only memory, and communications media conveying signals encoding the instructions (e.g., signals from a network). In order to attach computer system 501 to another computer system to copy files over a network, LAN card 530 is coupled to PCI bus 525 and to PCI-to-ISA bridge 535. Similarly, to connect computer system 501 to an ISP to connect to the Internet using a telephone line connection, modem 575 is connected to serial port 565 and PCI-to-ISA Bridge 535.

While the computer system described in FIG. 5 is capable of executing the invention described herein, this computer system is simply one example of a computer system. Those skilled in the art will appreciate that many other computer system designs are capable of performing the invention described herein.

Another embodiment of the invention is implemented as a program product for use with a computer system such as, for example, the systems 100 and 200 shown in FIG. 1 and FIG. 2. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

While the foregoing is directed to example embodiments of the disclosed invention, other and further embodiments of the invention may be devised without departing from the basic scope thereof, and the scope thereof is determined by the claims that follow.

What is claimed is:

1. An improved method for tracking code development, the method comprising:
receiving, by a single application within an integrated development environment, a status request;
requesting, by the single application, data, responsive to the status request, from at least one management tool in communication with the single application;
collecting the data from the at least one management tool to the single application; and
generating, by the single application, a status report based on the data.

2. The method of claim 1, further comprising distinguishing, by the single application, between previous status reports and the status report.

3. The method of claim 1, further comprising storing the status report after the generating.

4. The method of claim 1, further comprising configuring an interface for the status report to be produced by the generating.

5. The method of claim 1, further comprising distilling, by the single application, metrics from the status report after the generating.

6. The method of claim 1, wherein the generating further comprises publishing the report.

7. A system for tracking code development within an integrated development environment, the system comprising:
a single application within the integrated development environment;
a receiver module of the single application for receiving a status request;
a request module of the single application for requesting data for the status request from at least one management tool in communication with the single application;
a collection module of the single application for receiving the data from the at least one management tool; and
a generation module of the single application for generating a status report based on the data.

8. The system of claim 7, wherein the single application further comprises a comparison module for distinguishing between previous status reports and the status report.

9. The system of claim 7, wherein the single application further comprises a storage module for storing the status report after execution by the generation module.

10. The system of claim 7, wherein the single application further comprises a configuration module for configuring an interface for the status report.

11. The system of claim 7, wherein the single application further comprises a distillation module for distilling metrics from the status report after execution by the generation module.

12. The system of claim 7, wherein the generation module comprises a publication module for publishing the status report.

13. The system of claim 7, wherein the single application comprises a plug-in integrated into the integrated development environment.

14. The system of claim 13, wherein the plug-in comprises one or more connectors to the at least one management tool.

15. A machine-accessible medium containing instructions, which when executed by a machine, cause the machine to perform operations for tracking code development, comprising:
receiving, by a single application within an integrated development environment, a status request;
requesting, by the single application, data, responsive to the status request, from at least one management tool in communication with the single application;
collecting the data from the at least one management tool to the single application; and
generating, by the single application, a status report based on the data.

16. The machine-accessible medium of claim 15, wherein the instructions further comprise operations for distinguishing, by the single application, between previous status reports and the status report.

17. The machine-accessible medium of claim 15, wherein the instructions further comprise operations for storing the status report after performing the operations for generating.

18. The machine-accessible medium of claim 15, wherein the instructions further comprise operations for configuring an interface for the status report.

19. The machine-accessible medium of claim 15, wherein the instructions further comprise operations for distilling, by the single application, metrics from the status report after performing the operations for generating.

20. The machine-accessible medium of claim 15, wherein the instructions for generating further comprise instructions for publishing the status report.
